(19) United States
(12) Patent Application Publication
(10) Pub. No.: US 2024/0213802 A1
(43) Pub. Date: Jun. 27, 2024

(54) WIRELESS CHARGING COIL MODULE INCLUDING ROLLED COPPER LAYER ON ONE SURFACE OF BASE, METHOD FOR MANUFACTURING THE SAME, AND WIRELESS CHARGING SYSTEM INCLUDING THE SAME

(71) Applicant: WITS Co., Ltd., Yongin-si (KR)

(72) Inventors: Du Hyun SONG, Suwon-si (KR); Chun Su YOON, Suwon-si (KR); Dong Hyun KIM, Suwon-si (KR); Seung Jae BAECK, Suwon-si (KR); Yong Gu YOON, Suwon-si (KR)

(73) Assignee: WITS Co., Ltd., Yongin-si (KR)

(21) Appl. No.: 18/186,616

(22) Filed: Mar. 20, 2023

(30) Foreign Application Priority Data
Dec. 21, 2022 (KR) 10-2022-0180586

(51) Int. Cl. H02J 50/00; H01F 27/28; H01F 27/34; H01F 38/14; H01F 41/04; H02J 50/10

(52) U.S. Cl. CPC H02J 50/005; H01F 27/28; H01F 27/34; H01F 38/14; H01F 41/04; H02J 50/10

(57) ABSTRACT

Disclosed is a wireless charging coil module for wirelessly receiving or transmitting electric power or signals by using electromagnetic fields including a base, and a coil part including a coil provided on one surface of the base to be rotated in one direction. The coil includes a rolled thin plate of a conductive metal disposed on the one surface of the base, and a side part of the coil has a shape, a central portion of which protrudes or is recessed.

### CROSS-REFERENCE TO RELATED APPLICATIONS

This application claims priority under 35 U.S.C. § 119 to Korean Patent Application No. 10-2022-0180586 filed on Dec. 21, 2022, in the Korean Intellectual Property Office, the disclosures of which are incorporated by reference herein in their entireties.

### BACKGROUND

Embodiments of the present disclosure described herein relate to a wireless charging coil module including a rolled copper layer on one surface of a base, a method for manufacturing the same, and a wireless charging system including the same.

In recent years, a wireless power transfer (WPT) function, a near field communication (NFC) function, a magnetic secure transmission (MST) function, and the like have been employed in mobile portable devices. The WPT, NFC, and MST technologies are different in operation frequencies, data transmission rates, electric energy transmitted, and the like.

In a wireless power transmitting device, various forms of coils are used, and the WPT, NFC, and MST technologies are implemented by using a magnetic field and an electric field formed by the coils.

Recently, as requirements for small sizes and multiple functions of electronic devices have been increased, wireless charging modules and magnetic sheets included therein need to be small-sized, and demands on wireless charging coil modules having a transmission performance for signals and electric power at high efficiency have been increased as well.

### SUMMARY

Embodiments of the present disclosure provide a wireless charging coil module including a roller copper layer on one surface of a base. which may allow high-speed charging of 30 W or more by manufacturing a coil by using the roller copper layer on the one surface of the base, a method for manufacturing the same, and a wireless charging system including the same.

According to an embodiment, a wireless charging coil module for wirelessly receiving or transmitting electric power or signals by using electromagnetic fields includes a base, and a coil part including a coil provided on one surface of the base to be rotated in one direction, the coil includes a rolled thin plate of a conductive metal disposed on the one surface of the base, and a side part of the coil has a shape, a central portion of which protrudes or is recessed.

In an embodiment of the present disclosure, a thickness of the coil may be 60 μm to 500 μm.

In an embodiment of the present disclosure, the side part may include a first inclined part disposed adjacent to the base, and having a first inclination angle with respect to a lower surface of the coil, and a second inclined part extending upwards from one end of the first inclined part, and having a second inclination angle with respect to an upper surface of the coil, and the first inclination angle and the second inclination angle may be the same.

In an embodiment of the present disclosure, the side part of the coil may have a shape, a central portion of which protrudes when the first inclination angle and the second inclination angle are obtuse angles.

In an embodiment of the present disclosure, the side part of the coil may have a shape, a central portion of which is recessed when the first inclination angle and the second inclination angle are acute angles.

In an embodiment of the present disclosure, the wireless charging coil module may further include a magnetic layer covering at least a portion of the coil while directly contacting the coil, and that acts an electromagnetic booster that enhances an intensity of the electromagnetic field generated on the surface of the coil, and the magnetic layer may decrease, among a skin effect and a proximity effect of an eddy current generated in the coil, the proximity effect by isolating electric power in a gap of the coil that is rotated in the one direction.

In an embodiment of the present disclosure, the base may include at least one of polyimide (PI), polyethylene terephthalate (PET), and an epoxy resin.

According to an embodiment, a method for manufacturing a wireless charging coil module includes a rolled thin plate preparing operation of preparing a rolled thin plate of a conductive metal, a first rolled thin plate patterning operation of performing first patterning by using a first photoresist pattern provided on the rolled thin plate, a base attaching operation of disposing a base on a surface of the rolled thin plate, on which the first patterning is performed, and a second rolled thin plate patterning operation of forming a coil disposed on the base by performing second patterning by using a second photoresist pattern provided on an opposite surface to the surface of the rolled thin plate, on which the base is disposed, the second photoresist pattern is provided in an area corresponding to the first photoresist pattern, and an area that is removed from the rolled thin plate through the first patterning and an area that is removed from the rolled thin plate through the second patterning are connected to each other.

In an embodiment of the present disclosure, a depth, by which the rolled thin plate is etched through the first patterning, may be a half of a thickness of the rolled thin plate, and a depth, by which the rolled thin plate is etched through the second patterning, may be the half of the thickness of the rolled thin plate.

In an embodiment of the present disclosure, the first patterning and the second patterning may be wet etching.

According to an embodiment, a wireless charging system includes a wireless power receiving device including a receiver coil module, and a wireless power transmitting device including a transmitter coil module, at least one of the receiver coil module and the transmitter coil module includes a base, and a coil part including a coil provided on one surface of the base to be rotated in one direction, the coil includes a rolled thin plate of a conductive metal on the one surface of the base, and a side part of the coil has a shape, a central portion of which protrudes or is recessed.

### BRIEF DESCRIPTION OF THE FIGURES

The above and other objects and features of the present disclosure will become apparent by describing in detail embodiments thereof with reference to the accompanying drawings.

FIG. 1 is a perspective view schematically illustrating an external appearance of a wireless charging system according to an embodiment of the present disclosure;

FIG. 2 is a cross-sectional view schematically illustrating main internal configurations of FIG. 1;

FIG. 3 is a plan view illustrating a wireless charging coil module according to an embodiment of the present disclosure;

FIG. 4 is a plan view illustrating a wireless charging coil module according to an embodiment of the present disclosure;

FIG. 5 is a plan view illustrating that two coil parts are provided in a wireless charging coil module according to an embodiment of the present disclosure;

FIG. 6 is a plan view illustrating a shape of a wireless charging coil module according to an embodiment of the present disclosure;

FIGS. 7A and 7B are cross-sectional views taken along line A-A′ of FIG. 3, and are cross-sectional views illustrating a coil module including a coil part and a board;

FIG. 8 is a cross-sectional view illustrating a coil part illustrated in FIG. 7A;

FIG. 9 is a view illustrating a phenomenon, in which eddy current is generated on a surface of a coil;

FIG. 10 is a view illustrating a relationship between a surface depth of a coil and a density of eddy currents;

FIGS. 11 to 14 are views illustrating current densities of two conductors due to a proximity effect;

FIG. 15 is a flowchart illustrating a method for manufacturing a wireless charging coil module according to an embodiment of the present disclosure; and

FIGS. 16 to 22 are cross-sectional views illustrating a method for manufacturing a wireless charging coil module according to an embodiment of the present disclosure.

### DETAILED DESCRIPTION

The objectives, the specific advantages, and new features of the present disclosure will become clear from the following description and the preferred embodiments associated with the accompanying drawings. Throughout the specification, it is noted that the same or like reference numerals denote the same or like components even though they are provided in different drawings. Furthermore, in a description of the present disclosure, a detailed description of related known technologies may be omitted when it may make the essence of the present disclosure unnecessarily unclear.

Further, the accompanying drawings are provided only to help understand the embodiments disclosed in the specification more easily but the technical spirit disclosed in the specification is not limited by the accompanying drawings and it construed to include all changes, equivalents, and replacements included in the spirit and technical range of the present disclosure.

Furthermore, the terms including ordinal numbers, such as first and second, may be used to describe various components, but the components are not limited to the terms. The terms are used only for the purpose of distinguishing one component from another component.

Hereinafter, preferred embodiments of the present disclosure will be described in detail with reference to the accompanying drawings.

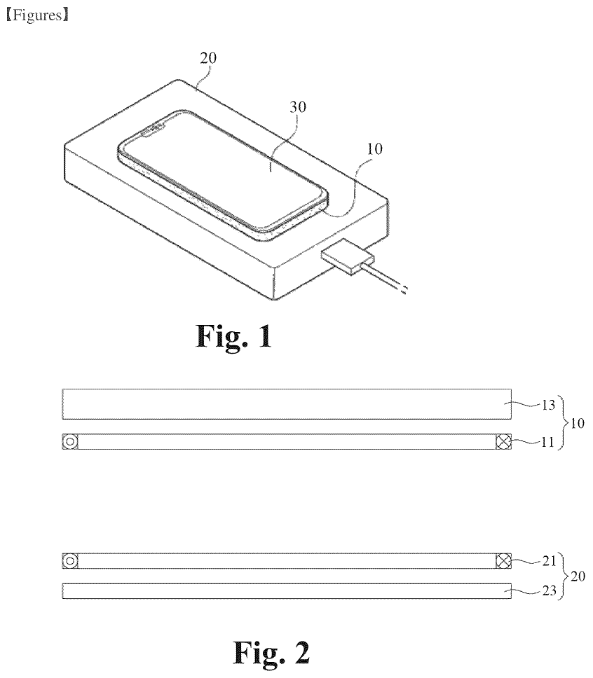

FIG. 1 is a perspective view schematically illustrating an external appearance of a wireless charging system according to an embodiment of the present disclosure. FIG. 2 is a cross-sectional view schematically illustrating main internal configurations of FIG. 1.

Referring to FIGS. 1 and 2, a wireless charging system may include a wireless power transmitting device 20 and a wireless power receiving device 10. The wireless power receiving device 10 may include various electronic devices 30 such as a mobile phone, a notebook, and a table PC.

The wireless power receiving device 10 may include a battery 13, and a receiver coil module 11 for charging the battery 13 by supplying electric power to the battery 13.

The battery 13 may be a secondary battery that may be charged and discharged. For example, the battery 13 may be a nickel hydrogen battery or a lithium ion battery, but the present disclosure is not particularly limited thereto. Furthermore, the battery 13 may be implemented to be provided separately from the wireless power receiving device 10 to be attached to or detached from the wireless power receiving device 10, or may be implemented of an integral type to be integrally formed with the battery 13 and the wireless power receiving device 10.

The wireless power transmitting device 20 may wirelessly transmit electric power to charge the battery 13 of the wireless power receiving device 10. The wireless power transmitting device 20 may include a device board and a transmitter coil module 21 in an interior thereof. The transmitter coil module 21 may be provided on the device board.

The wireless power transmitting device 20 may convert AC power supplied from an outside to DC power, and in turn may convert the DC power to an AC voltage of a specific frequency to provide the AC voltage to the wireless power receiving device 10. A magnetic field of the transmitter coil module 21 is changed when the AC voltage is applied to the transmitter coil module 21 in the wireless power transmitting device 20. When a magnetic field formed by the transmitter coil module 21 is changed, a magnetic field in the receiver coil module 11 of the wireless power receiving device 10 also is changed, and the battery 13 is charged as a voltage is applied according to the change in the magnetic field in the receiver coil module 11.

The transmitter coil module 21 and the receiver coil module 11 may be electrically coupled to each other. The transmitter coil module 21 and the receiver coil module 11 may have a coil, in which a metallic wiring line of copper and the like, for example, a metal wire or a metal pattern is wound on a flat surface. In this case, a winding shape of the coil may be a circular shape, a quadangular shape, and a rhombus shape, and the entire size or the number of windings thereof may be properly controlled according to required characteristics.

A magnetic sheet may be additionally disposed between the receiver coil module 11 and the battery 13 and/or between the transmitter coil module 21 and the device board. Then, the magnetic sheet may be located between the receiver coil module 11 and the battery 13 to collect magnetic fluxes, and thus signals may be received by the receiver coil module 11. In addition, the magnetic sheet functions to interrupt at least some of the magnetic fluxes from reaching the battery 13.

In an embodiment of the present disclosure, the coil may be used for magnetic secure transfer (MST), near field wireless communication (NFC), and the like, in addition to the wireless charging device. This will be described later.

Hereinafter, both of the transmitter coil module 21 and the receiver coil module 11 will be referred to as coil modules when it is not specifically distinguish them, and the receiver coil module will be described as an example in the following embodiments.

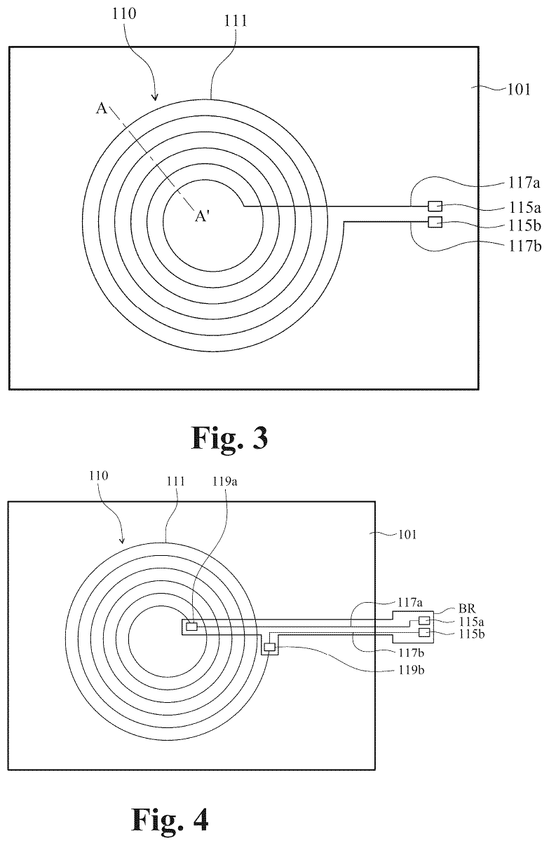

Hereinafter, referring to FIGS. 3 to 6, various shapes of the coil module 11 will be described.

FIG. 3 is a plan view illustrating a wireless charging coil module according to an embodiment of the present disclosure.

Referring to FIG. 3, an electronic device (for example, the wireless charging device) may include a wireless charging coil module that wirelessly receives or transmits electric power or signals by using electromagnetic fields. The wireless charging coil module may include a base 101 and a coil part 110 provided on at least one surface thereof.

The base 101 has a flat plate shape (or a sheet shape), and may be disposed on one side of the coil part 110. The coil part 110 may be provided directly on one surface of the base 101 or may be provided on one surface of the base 101 while another component such as an adhesive being interposed therebetween. Hereinafter, the coil part 110 provided on one surface of the base 101 is described as an example, but the relationship between the coil part 110 and the base 101 is not limited thereto, and coil parts 110 may be provided on opposite surfaces of the base 101.

The base 101 is formed of a material that has a heat-resistant property and a pressure-resistant property. The base 101 may be formed of a magnetic material. That is, the base 101 may be formed of a magnetic sheet. The magnetic sheet may be provided to efficiently form a magnetic path of magnetic fields generated by a coil 111. To achieve this, the magnetic sheet also may be formed of a material that may easily form a magnetic path. The magnetic sheet may be a ferrite sheet. However, the magnetic sheet has a magnetism and is not limited only to the ferrite sheet, and may be at least one of a ferrite sheet, a soft ferrite metal sheet, and a hybrid type sheet, to which a metal and a ferrite is complexly applied. Furthermore, the magnetic sheet may be a thin sheet that is manufactured by making a metal thin film thinner and distributing and pressing on an insulating resin. Various ferrite material compositions may be used, and for example, Fe, Fe—Si, Fe—Al—Si, Fe—Ni, and Fe—Co may be used, and various materials other than a ferrite may be used so long as they are magnetic materials.

The base 101 may be formed of other insulating materials. For example, the base 101 may be formed of a polymeric material. In particular, the base 101 may include at least one of polyimide (PI), polyethylene terephthalate (PET), and an epoxy resin.

However, the material of the base 101 is not limited thereto, and the base 101 may be a printed circuit board (PCB), a ceramic board, a pre-molded board, or a direct bonded copper (DBC) board, or may be an insulating metal substrate (IMS). However, the material of the base 101 is not limited thereto, and various insulating materials may be used. When the base 101 is formed of a material other than the magnetic material, a separate magnetic sheet may be additionally provided between the base 101 and the battery. In this case, the additional magnetic sheet may be used to efficiently form a magnetic path of magnetic fields and interrupt the magnetic path in the direction of the battery at the same time.

In an embodiment of the present disclosure, the base 101 may be rigid, but the present disclosure is not limited thereto. For example, the base 101 may be flexible. The rigid or flexible board may be provided in various forms, and for example may be provided as a rigid printed circuit board, a flexible printed circuit board, or a rolled copper printed circuit board that may be used as a lead frame.

The coil part 110 may be provided on at least one surface of the base 101 in a form of a wiring line. That is, the coil part 110 may be provided on a plane defined by one surface of the base 101, on at least one surface of the base 101, and may include a coil having a spiral shape.

The coil part 110 also may include first and second extraction parts 117a and 117b that extend from a central distal end and an outer distal end of the spiral coil 111 to an outside, and first and second terminal parts 115a and 115b provided at ends of the first and second extraction parts 117a and 117b to be connected to other configurations (for example, a circuit part). In an embodiment of the present disclosure, it is illustrated that the first and second terminal parts 115a and 115b are provided in the quadangular base 101, but the present disclosure is not limited thereto, and they may extend for electrical connection to the outside and protrude from one side of the base 101. The first and second terminal parts 115a and 115b may include a plurality of connection terminals.

In an embodiment of the present disclosure, the coil 111 may be a circular, elliptical, or polygonal flat coil that is wound in a clockwise or counterclockwise direction. The shape of the coil 111 is not limited to the drawing, and may be in a form of a winding. The coil 111 may include a rolled thin plate of the conductive metal. For example, the coil 111 may include a rolled copper layer. The rolled copper layer may have a very high purity as compared with electrolytic copper foil. Accordingly, a resistance of the coil 111 manufactured by using the rolled copper layer may be low as compared with that of the coil manufactured by using the electrolytic copper foil. Furthermore, in an embodiment of the present disclosure, the coil 111 may be disposed on only one surface of the base 101.

In an embodiment of the present disclosure, the coil 111 may be disposed in a spiral form, in which it starts from a central portion of the base 101 and is rotated in one direction. Then, according to the embodiment, a rotational direction of the coil 111 may be provided to be rotated spirally from an inner side to an outer side. Although it is illustrated that the coil 111 has a circular spiral shape in the drawing, the present disclosure is not limited thereto, and any spiral shape that may be rotated to generate resonances in the same current direction may be applied.

The above-described coil 111 may function as the coil for wireless power transfer (WPT) when transmission of electric power is required, may function as the coil 111 for magnetic secure transmission (MST) when magnetic information has to be transmitted wirelessly, and may be provided as the coil for near field communication (NFC). Although it has been described as an example in an embodiment of the present disclosure that the coil 111 performs multiple functions, the present disclosure is not limited thereto, and the coil 111 may include the coil for WPT that performs a power transmission function.

The coil 111 may be provided only on a front surface of the base 101, or coils 111 may be provided on both the front surface and a rear surface thereof. When the coils 111 are provided on both the front surface and the rear surface, the two coils 111 may be electrically separated from each other, or at least portions thereof may be connected to each other through a via to be electrically connected to each other. In other words, when the coils 111 are formed on opposite surfaces of the base 101, opposite ends of each of the coils 111 may be connected to each other such that the coils 111 constitutes a parallel circuit, or ends at the centers thereof may be connected to each other to constitute a series circuit. To achieve this, a conductive via (not illustrated) for electrically connecting the coils 111 may be formed in interiors of the coils 111.

Here, at least one of the first and second extraction parts 117a and 117b may be disposed while an insulator that is separate from a crossing wiring line to prevent a short circuit with the crossing wiring line being interposed between the at least one of the first and second extraction parts 117a and 117b and the crossing wiring line, or may be connected to the wiring line through a wiring line provided on another surface through a via.

The above-described structure of the coil module has been described as an example, and in the embodiment of the present disclosure, connection relationships thereof and the number or a disposition of the coils 111 may be modified in various forms.

FIG. 4 is a plan view illustrating the wireless charging coil module according to an embodiment of the present disclosure.

Referring to FIG. 4, the wireless charging coil module according to an embodiment of the present disclosure may be manufactured such that extraction parts and terminal parts connected to the opposite ends of the coil part 110 have separate configurations to be connected to each other. That is, the coil 111, and the first and second extraction parts 117a and 117b and the first and second terminal parts 115a and 115b connected to the opposite ends of the coil 111 may not be disposed on the base 101 like the spiral coil 111 on the base 101, but may make as a bridge BR that is a separate configuration separated from the base 101 to be attached to the base 101. Here, first and second pad parts (not illustrated) are provided at the opposite ends of the coil 111. The bridge BR may include first and second bridge pads 119a and 119b corresponding to the first and second pad parts of the opposite ends of the coil 111, the first and second extraction parts 117a and 117b connected to the first and second bridge pads 119a and 119b, respectively, and the first and second terminal parts 115a and 115b connected to the first and second extraction parts 117a and 117b. The first and second bridge pads 119a and 119b, the first and second extraction parts 117a and 117b, and the first and second terminal parts 115a and 115b may be formed on the bridge base 101, and the bridge base 101 may be a rigid or flexible base 101.

The first and second bridge pads 119a and 119b may be connected to the first and second pad parts of the coil 111 by a conductor. As an example, the first and second bridge pads 119a and 119b and the first and second pad parts of the coil 111 may be connected to each other through soldering using heat, ultrasonic waves, laser beams, or the like, but the present disclosure is not limited thereto, and they may be variously joined to each other, for example, by using an amorphous conductive film.

Here, the configuration of the bridge BR is an example for electrically connecting the opposite ends of the coil 111 to another configuration, and the present disclosure is not limited thereto and may be modified in various forms.

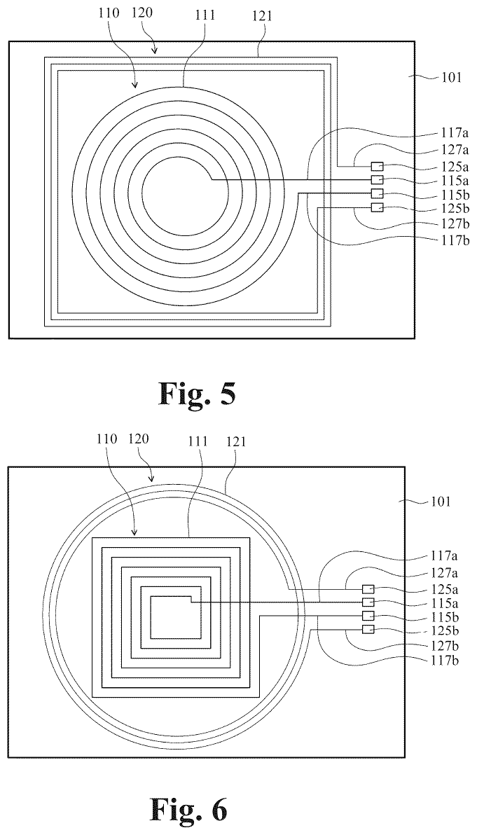

FIG. 5 is a plan view illustrating that the two coil parts are provided in the wireless charging coil module according to an embodiment of the present disclosure.

In the present embodiments, to distinguish different coil parts, the coil part described in the above-described embodiment is described as the first coil part 110 and an added coil part is described as a second coil part 120, and an aspect that is different from that of the above-described embodiment will be mainly described for convenience of description.

In the embodiment of the present disclosure, the wireless coil charging module may include the first coil part 110 provided on at least one surface of the base 101 and having a spiral shape, and the second coil part 120 provided on at least one surface of the board and disposed on an outside of the first coil part 110.

Referring to FIG. 5, the first coil part 110 includes the first spiral coil 111, the first and second extraction parts 117a and 117b and the first and second terminal parts 115a and 115b connected to the first spiral coil 111, and the second coil part 120 includes a second spiral coil 121, first and second extraction parts 127a and 127b and the first and second terminal parts 115a and 115b connected to the second spiral coil 121.

The second coil 121 is provided on at least one surface of the base 101, and is disposed on an outside of the first coil 111 to have a shape that surrounds the first coil 111 as a whole. Although it is illustrated in the embodiment of the present disclosure that the second coil 121 has separate extraction parts and terminal parts, the present disclosure is not limited thereto, and one end of the second coil 121 may be connected to the first coil 111 and an opposite end thereof may be connected to the terminal part.

The second coil 121 is disposed at an outskirt of the first coil 111 as a whole, but the present disclosure is not limited thereto, and at least a portion thereof may be provided to cross the first coil 111.

In an embodiment of the present disclosure, the second coil 121 may function as a coil for MST when it is necessary to wirelessly transmit magnetic information, and may be used as a coil for NFC for near field wireless communication.

In an embodiment of the present disclosure, when a frequency band of the second coil 121 is higher than a frequency band of the first coil 111, the second coil 121 may have a conductive pattern of a line width that is smaller than that of the first coil 111, and an interval of wiring thereof may be smaller than that of the first coil 111.

In an embodiment of the present disclosure, the wireless charging coil module may have various shapes.

FIG. 6 is a plan view illustrating a shape of the wireless charging coil module according to an embodiment of the present disclosure, and unlike FIG. 5, discloses that spiral arrangements of the first coil 111 and the second coil 121 on a flat surface have different shapes.

Referring to FIG. 6, the first coil 111 has one quadangular shape of a spiral structure when viewed on a plane, and the second coil 121 has a circular shape of a spiral structure at an outskirt of the first coil 111. The above-described embodiment of FIG. 5 is different from the present embodiment in that the first coil 111 has a circular shape and the second coil 121 has a quadangular shape. In this way, the first coil 111 and the second coil 121 may have different shape, and may be variously modified without departing from the present disclosure even though not illustrated here.

In FIGS. 5 and 6, the first coil 111 and the second coil 121 may be independently used as any one of a coil for WPT, a coil for NFC, and a coil for MST. A combination of the first coil 111 and the second coil 121 for example, may be used for a coil for WPT and a coil for NFC, a coil for MST and a coil for WPT, or a coil for MST and a coil for NFC. However, the purpose of the coil is not limited thereto, and it is apparent that the coil may be used for another purpose and a coil that is not disclosed may be further added.

According to an embodiment of the present disclosure, in the above-described various wireless charging coil modules, the coil parts 110 and 120 may be formed of a rolled thin plate of a conductive metal.

Hereinafter, the wireless charging coil module including the coil parts 110 and 120 formed of a rolled thin plate of a conductive metal will be described in more detail, and the first coil part 110 will be described as an example of the coil parts 110 and 120 for convenience of description.

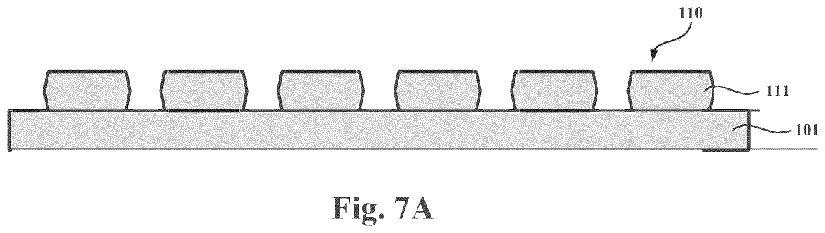

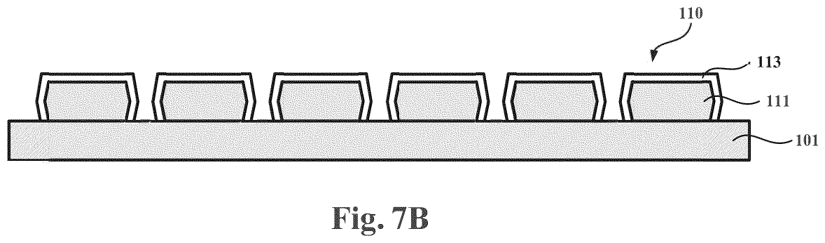

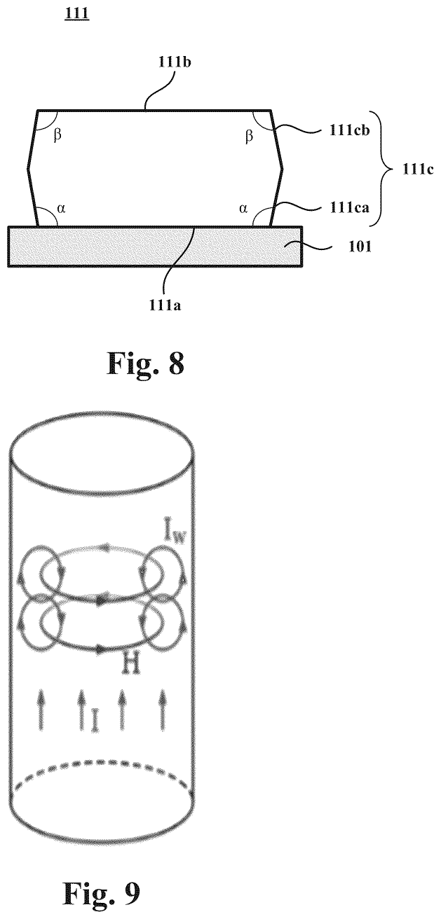

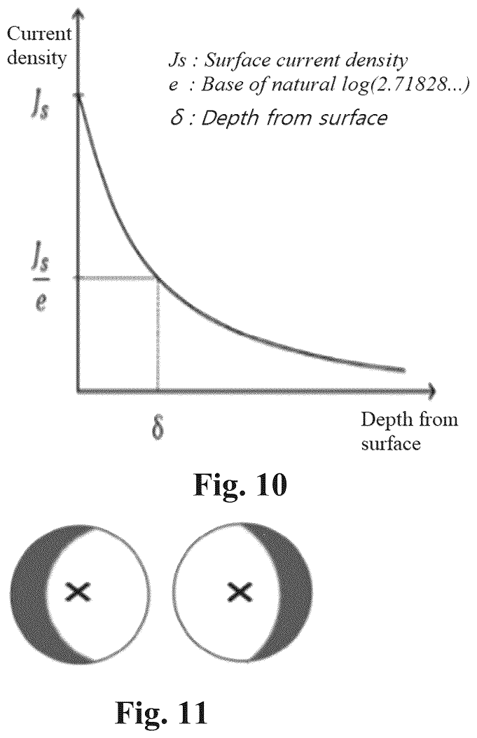

FIGS. 7A and 7B are cross-sectional views taken along line A-A′ of FIG. 3, and are cross-sectional views illustrating the coil module including the coil part and the board. FIG. 8 is a cross-sectional view illustrating the coil part illustrated in FIG. 7A. FIG. 9 is a view illustrating a phenomenon, in which eddy current is generated on a surface of the coil. FIG. 10 is a view illustrating a relationship between a surface depth of the coil and a density of eddy currents. FIGS. 11 to 14 are views illustrating current densities of two conductors due to a proximity effect.

Referring to FIGS. 3, 7A, 7B, and 8 to 14, the wireless charging coil module may include the base 101 and the coil part 110.

The base 101 is formed of a material that has a heat-resistant property and a pressure-resistant property. The base 101 may be formed of various materials. For example, the base 101 may be formed of a magnetic sheet. Furthermore, the base 101 may be formed of an insulating sheet. However, the material of the base 101 is not limited to the above-described magnetic material or insulating sheet. For example, the base 101 may be a printed circuit board (PCB), a ceramic board, a pre-molded board, or a direct bonded copper (DBC) board, or may be an insulating metal substrate (IMS).

Furthermore, the base 101 may be rigid or flexible.

Meanwhile, an insulation part (not illustrated) may be provided between the base 101 and the coil part 110.

The insulation part may be provided between the base 101 and the coil part 110 in a form of a membrane or a film. The insulation part is not limited as long as it is formed of a material that may insulate the base 101 and the coil part 110, and may be formed of various materials. For example, the insulation part may include an organic insulation film, an inorganic insulation film, or an insulation film formed of an organic-inorganic ionic thermocouple composite material.

The coil 111 of the coil part 110 may be a circular, elliptical, or polygonal flat coil that is wound in a clockwise or counterclockwise direction. The shape of the coil 111 is not limited to the drawing, and may be in a form of a winding.

The coil 111 may include a rolled thin plate of the conductive metal. For example, the coil 111 may include a rolled copper layer disposed on only one surface of the base 101. The rolled copper layer may have a very high purity as compared with electrolytic copper foil. Accordingly, a resistance of the coil 111 manufactured by using the rolled copper layer may be low as compared with that of the coil manufactured by using the electrolytic copper foil.

In an embodiment of the present disclosure, as illustrated in FIGS. 7A, 7B, and 8, the coil 111 may have a shape, of which a central portion of a side part of which protrudes. In more detail, a cross-section of the coil 111, which is perpendicular to the base 101, may have a shape that is close to a rectangular shape as a whole. For example, the cross-section of the coil 111, which is perpendicular to the base 101, may include a lower side 111a and an upper side 111b, and lateral sides 111c that connect ends of the lower side 111a and the upper side 111b. Here, the lower side 111a may contact the base 101, the upper side 111b may face the lower side 111a, and the lateral sides 111c may correspond to the side parts of the coil 111. However, the lateral sides 111c, that is, the side parts of the coil 111 may include a first inclined part 111ca on a lower side and a second inclined part 111cb on an upper side. That is, the first inclined part 111ca may be disposed adjacent to the base 101, and the second inclined part 111cb may have a shape that extends upwards from one end of the first inclined part 111ca.

The first inclined part 111ca may have a shape that is inclined at a first inclination angle α with respect to the lower side 111a, that is, a lower surface of the coil 111 or the flat surface of the base 101. Here, the first inclination angle α may be 90° to 100°.

The second inclined part 111cb may have a shape that is inclined at a second inclination angle β with respect to the upper side 111b, that is, an upper surface of the coil 111. Here, the second inclination angle β may be 90° to 100°.

Furthermore, a size of the first inclination angle α and a size of the second inclination angle β may be the same, and the first inclination angle α and the second inclination angle β may be obtuse angles. Accordingly, the side part of the coil 111 may have a shape, a central portion of which protrudes.

Meanwhile, FIGS. 7A, 7B, and 8 illustrate as an example that the coil 111 has a shape, of which a central portion of the side part protrudes, but the present disclosure is not limited thereto. For example, the coil 111 may have a shape, of which the central portion of the side part is recessed. When the central portion of the side part of the coil 111 has a recessed shape, the size of the first inclination angle α and the size of the second inclination angle β may be the same, and the first inclination angle α and the second inclination angle β may be acute angles.

Furthermore, a height of the coil 111 in a direction that is perpendicular to the base 101, that is, a thickness “d” of the coil 111 may be 60 un to 500 μm.

When the thickness “d” of the coil 111 is 60 μm or less, it may be difficult to use the coil 111 in high-speed wireless charging of 30 W or more by using the wireless charging module including the coil 111. This is because it is difficult to transmit high-capacity currents because the thickness of the coil 111 is small.

When the thickness “d” of the coil 111 is 500 μm or more, an effective cross-sectional area of the coil 111 may decrease and an effective resistance may increase because no current flows in an interior of the coil 111 due to the skin effect.

Meanwhile, as illustrated in FIG. 9, when alternating currents flow into an interior of the conductor in the coil 111, magnetic fields due to Ampere's law (the right handed screw rule) may be generated.

Furthermore, currents may be generated in a direction, in which generation of magnetic fields is restrained due to Lentz's law (a direction of an induced voltage). The currents generated by the Lentz's law may be generated in a shape of a chain with respect to a magnetic field in a direction that is perpendicular to a direction of the magnetic field.

In this way, currents generated in a shape, such as a chain, which is formed by the Lentz's law in a direction that is perpendicular to a magnetic field due to the Ampere's law are called eddy currents. When the eddy currents are generated, the current may be lost as heat is generated in the coil 111. This is called an eddy current loss.

Furthermore, the skin effect is a phenomenon that occurs due to magnetic fields due to the Ampere's law generated from alternating currents that are to pass through the coil 111 due to electromagnetic induction, induced currents due to the Lentz's law generated thereby, and eddy currents generated in an interior of the conductor due to the included currents, and is a phenomenon, in which currents flow while being concentrated near the surface of the conductor.

Due to the above-described skin effect, as illustrated in FIG. 10, an effective cross-section may decrease and an effective resistance may increase as no current flows in an interior of the coil 111.

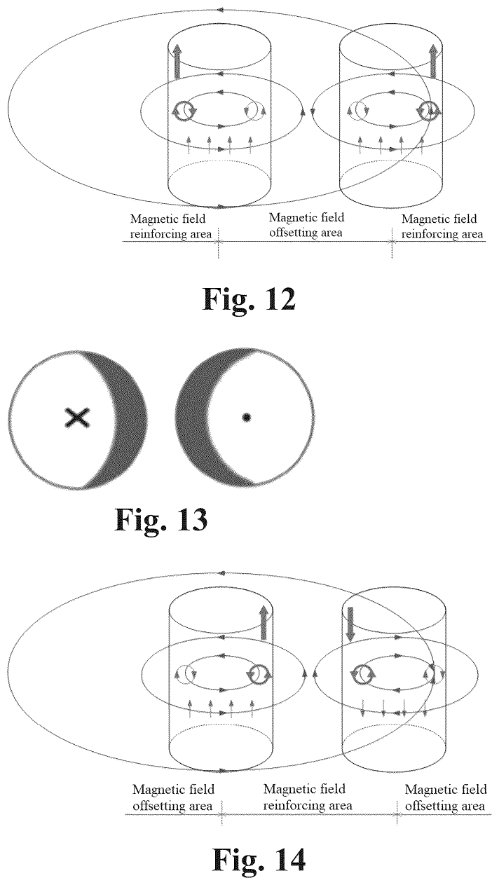

Meanwhile, a proximity effect may occur while currents flow in the coil 111. As illustrated in FIGS. 11 and 12, due to the proximity effect, a current density may increase in areas of two conductors that approaches each other when directions of the currents that flow in the two conductors are opposite to each other.

Furthermore, as illustrated in FIGS. 13 and 14, due to the proximity effect, a current density may increase in areas of two conductors in opposite directions when the directions of the currents that flow in the two conductors are the same.

Due to the proximity effect, an effect area, in which the currents flow, may decrease and a current transmission loss may increase.

As described above, the skin effect and the proximity effect influence eddy currents, and the loss of the eddy currents may decrease when at least one of the skin effect and the proximity effect is reduced.

Meanwhile, as illustrated in FIG. 7B, a magnetic layer 113 may be provided on the coil 111 to reduce the above-described loss of the eddy currents. The magnetic layer 113 may cover at least a portion of the exposed surface of the coil 111 while directly contacting the coil 111. The magnetic layer 113 may be formed on a surface of the coil 111 through a process such as plating, deposition, or coating.

The magnetic layer 113 is provided to increase a wireless charging efficiency in the transmission/reception coil 111 of the wireless charger and lower a heat emission temperature in the charger. To achieve this, the magnetic layer 113 needs to directly contact the coil 111, and at least a portion of the magnetic layer 113 directly contacts the coil 111. When another configuration is interposed between the magnetic layer 113 and the coil 111, an effect and a heat dissipation effect of the following magnetic layer 113 may be decreased.

The magnetic layer 113 has a high permeability, and the magnetic layer 113 is provided on the coil 111 to function to strongly boost an intensity of an electromagnetic field generated on a surface of the coil 111. It appears that the phenomenon occurs because permeability is enhanced, permeability loss is lowered, and a frequency bandwidth for use of wireless charging is enhanced by adding a high magnetic component on the coil 111, and accordingly, it is determined that wireless charging efficiency is increased and a surface density of the electromagnetic field generated in the coil 111 is further concentrated on the surface of the coil 111.

The magnetic layer 113 may be formed of a magnetic material. For example, the magnetic body constituting the magnetic layer 113 may be a metal pallet, a nano crystal, an amorphous material, a metal-based or ferrite pellet, a ferrite complex, a sendust pallet, and a sendust complex. The material of the magnetic body is not specifically limited.

In an embodiment of the present disclosure, the magnetic layer 113 may include an alloy magnetic body or a ferrite magnetic body including a combination of two or three or more elements selected from a group consisting of Fe, Ni, Co, Mn, Al, Zn, Cu, Ba, Ti, Sn, Sr, P, B, N, C, W, Cr, Bi, Li, Y, and Cd. In the magnetic layer 113, a permeability of the magnetic body manufactured may be controlled. through a process of heat-treating or mixing the materials In particular, a permeability Ur of the product may be changed through a process of heat-treating or mixing the materials including Fe, Ni, Mn, Si, B, and C. In an embodiment of the present disclosure, particularly, main substances of the magnetic layer 113 may be Ni and FE, and the permeability Ur and a magnetic flux density Bs may be controlled by adjusting a content of Fe. Furthermore, the magnetic layer 113 is a soft magnetic material, and a coercive force thereof may be controlled by adjusting contents of Ni and Fe. In an embodiment of the present disclosure, in addition to the materials of the magnetic layer 113, Si and/or B may be added as impurities.

According to an embodiment of the present disclosure, the coil 111 of the coil module according to the embodiment of the present disclosure is divided into a plurality of parts and a surface thereof is divided into a plurality of areas, and a skin effect is maximized by providing a wiring line covered with the magnetic layer 113 on the surface of the coil 111. Furthermore, a proximity effect of the adjacent wiring lines may be reduced through the structure having the plurality of divided parts. That is, the magnetic layer 113 decreases, among the skin effect and the proximity effect of the eddy currents generated in the coil 111, the proximity effect, and this may be through a method of isolating electric power between the coil 111 and the coil 111 that are rotated in one direction by using the magnetic layer 113. In this way, when the skin effect is increased and the proximity effect is decreased, the eddy current effect may be minimized whereby the wireless charging efficiency may be increased and emission of heat may be reduced as well.

Through this, the coil module according to an embodiment of the present disclosure may have a high wireless charging efficiency while showing an excellent heat dissipation effect when low, middle, and high electric power is wirelessly transmitted and received for a long time.

That is, when being used as a charging wireless transmission/reception coil, the coil module according to an embodiment of the present disclosure having the above structure functions to strongly boost an intensity of an electromagnetic field by adding a magnetic body having a high permeability on a surface of the wireless charging transmission/reception coil. Because a high magnetic component is added to an interior of the wireless charger, permeability is enhanced, permeability loss is lowered, and a bandwidth of a frequency for use of wireless charging may be enhanced, and as a result, a wireless charging efficiency may be increased. Here, a surface density of the electromagnetic field generated by the wireless charging transmission/reception coil may be further concentrated on the surface of the coil.

In a conventional case, a magnetic sheet is provided at a lower portion of the coil 111, and a structure, in which heat dissipating sheets formed of a material, such as graphite, for dissipating heat separately from the magnetic sheet are used in many cases. In the stack structure, the magnetic sheets function as gates for causing an electromagnetic field radiated from the metal coil 111 to pass through a magnetic layer, and this functions to activate a horizontal electromagnetic field. However, in the present disclosure, because the coil 111 covers the horizontal electromagnetic field due to the magnetic body at a central portion thereof and the magnetic component as well, the covered magnetic body may be operated as an electromagnetic booster that further activates the electromagnetic field formed by the coil 111.

In an embodiment of the present disclosure, a shape of the first spiral coil 110c of the coil part 110, in particular, shapes of the coil 111 and the magnetic layer 113 may be changed to various shapes.

Furthermore, in an embodiment of the present disclosure, as the coil 111 is formed by using the rolled thin plate of the conductive metal, a specific resistance of the coil 111 may be lowered as a purity of the conductive metal included in the coil 111 is high. Accordingly, the coil module including the coil 111 formed by using the rolled thin plate of the conductive metal may be applied to the wireless charging system that performs high-speed charging of 30 W or more.

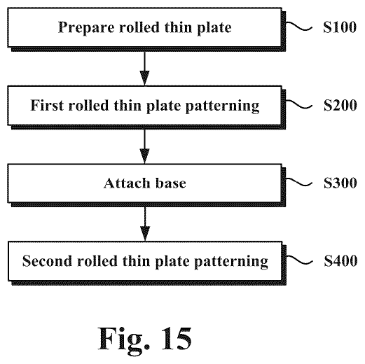

Hereinafter, referring to FIGS. 15 to 22, a method for manufacturing the wireless charging coil module illustrated in FIGS. 7 and 8 will be described.

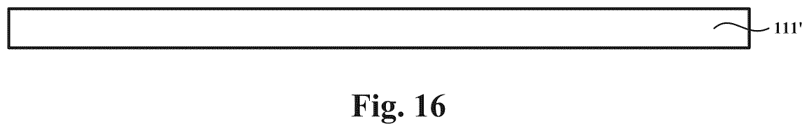

FIG. 15 is a flowchart illustrating a method for manufacturing the wireless charging coil module according to an embodiment of the present disclosure. FIGS. 16 to 22 are cross-sectional views illustrating a method for manufacturing the wireless charging coil module according to an embodiment of the present disclosure.

Referring to FIGS. 15 to 22, the method for manufacturing the wireless charging coil module according to an embodiment of the present disclosure may include a rolled thin plate preparing operation S100, a first rolled thin plate patterning operation S200, a base attaching operation S300, and a second rolled thin plate patterning operation S400 to manufacture the wireless charging coil module.

First, in the rolled thin plate preparing operation S100, a rolled thin plate 111′ as illustrated in FIG. 16 is prepared. The rolled thin plate 111′ may include the rolled thin plate of the conductive metal. For example, the rolled thin plate 111′ may include a rolled copper layer.

The rolled thin plate 111′ including the rolled copper layer may be manufactured by hot-rolling or cold-rolling a copper plate. The rolled copper layer may have a very high purity as compared with electrolytic copper foil. Accordingly, a resistance of the coil 111 manufactured by using the rolled copper layer may be low as compared with that of the coil manufactured by using the electrolytic copper foil.

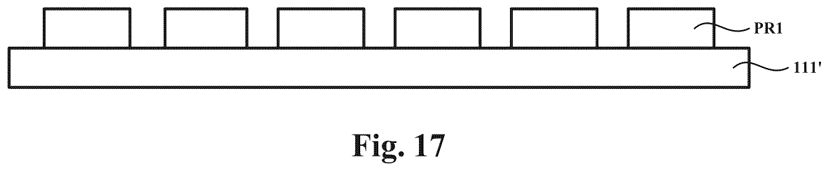

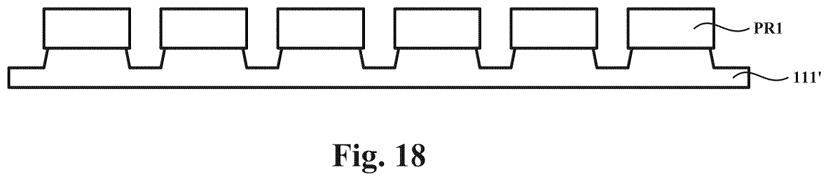

In the first rolled thin plate patterning operation S200, as illustrated in FIGS. 17 and 18, first patterning may be performed on the rolled thin plate 111′ by using a first photoresist pattern PR1.

In more detail, as illustrated in FIG. 17, the first photoresist pattern PR1 is formed on the rolled thin plate 111′. The first photoresist pattern PR1 may be formed by exposing and developing a photoresist disposed on the rolled thin plate 111′. Here, the photoresist may be provided in a form of a film to be attached onto the rolled thin plate 111′. The photoresist is provided in a liquid form to be applied onto the rolled thin plate 111′.

After the first photoresist pattern PR1 is formed, as illustrated in FIG. 18, the first patterning may be performed on the rolled thin plate 111′ through wet etching. Through the first patterning, an area of the rolled thin plate 111′, which is exposed by the first photoresist pattern PR1, may be removed by a specific depth, for example, by a half of a thickness of the rolled thin plate 111′. That is, through the first patterning, a half of the thickness of the rolled thin plate 111′ may be etched.

Because the wet etching has isotropic etching characteristics, a portion of the rolled thin plate 111′ at a lower portion of the first photoresist pattern PR1 may be removed. Accordingly, through the first patterning, a recess may be formed in the rolled thin plate 111′, and a side part of the recess may not be perpendicular to a surface of the rolled thin plate 111′ but may be inclined. Here, the side part of the recess may be the first inclined part 111ca, and the first inclined part 111ca may have the first inclination angle α.

When the first patterning is completed, the first photoresist pattern PR1 may be removed.

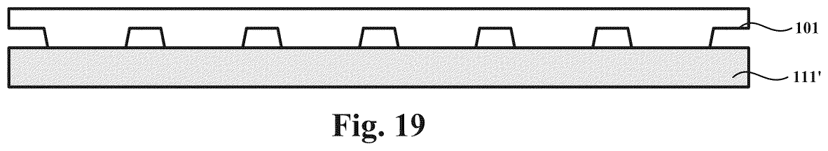

In the base attaching operation S300, after the first patterning is performed on the rolled thin plate 111′, as illustrated in FIG. 19, the base 101 is attached onto a surface of the rolled thin plate 111′, on which the first patterning is performed. That is, the rolled thin plate 111′ may be disposed on only one surface of the base 101.

The base 101 is formed of a material that has a heat-resistant property and a pressure-resistant property. The base 101 may be formed of various materials. For example, the base 101 may be formed of a magnetic sheet. Furthermore, the base 101 may be formed of an insulating sheet. However, the material of the base 101 is not limited to the above-described magnetic material or insulating sheet. For example, the base 101 may be a printed circuit board (PCB), a ceramic board, a pre-molded board, or a direct bonded copper (DBC) board, or may be an insulating metal substrate (IMS).

Furthermore, the base 101 may be rigid or flexible.

After the base 101 is attached onto the surface of the rolled thin plate 111′, on which the first patterning is performed, it may be reversed such that the base 101 is disposed at a lower portion of the rolled thin plate 111′ for the following processes.

In the second rolled thin plate patterning operation S400, after the base 101 is attached to the rolled thin plate 111′ and the base 101 is reversed such that the base 101 is disposed at a lower portion thereof, second patterning may be performed on the rolled thin plate 111′ to manufacture the coil 111.

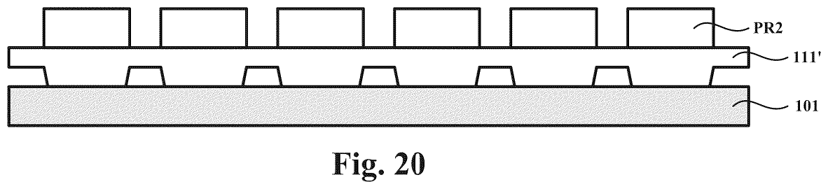

In more detail, after the base 101 is attached to the rolled thin plate 111′ and is reversed, as illustrated in FIG. 20, a second photoresist pattern PR2 is formed on a surface of the rolled thin plate 111′ in an opposite direction to a direction, in which the base 101 is disposed. Here, as in the first photoresist pattern PR1, the second photoresist pattern PR2 may be formed by exposing and developing a photoresist, and may be provided in an area corresponding to the first photoresist pattern PR1.

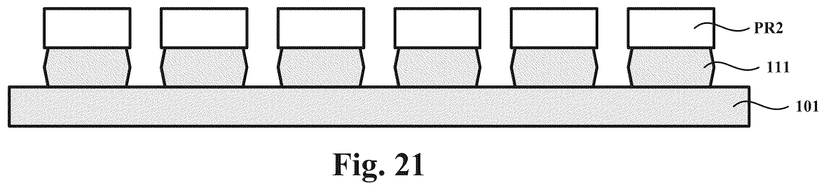

Thereafter, as illustrated in FIG. 21, the second patterning may be performed on the rolled thin plate 111′ through wet etching. Through the second patterning, an area of the rolled thin plate 111′, which is exposed by the second photoresist pattern PR2, may be removed by a specific depth, for example, by a half of a thickness of the rolled thin plate 111′.

As described above, because the second photoresist pattern PR2 is provided in an area corresponding to the first photoresist pattern PR1 and a half of the rolled thin plate 111′ is removed through the second patterning, an area removed through the first patterning and an area removed through the second patterning may be connected to each other. Accordingly, the coil 111 provided on the base 101 may be formed through the second patterning.

Furthermore, because the wet etching has isotropic etching characteristics, a portion of the rolled thin plate 111′ at a lower portion of the second photoresist pattern PR2 may be removed. Accordingly, through the second patterning, the side part in an area, in which the rolled thin plate 111′ is removed, may not be perpendicular to a surface of the rolled thin plate 111′ but may be inclined. Here, the side part may be the second inclined part 111cb, and the second inclined part 111cb may have the second inclination angle β.

Because both of the first patterning and the second patterning correspond to wet etching and thicknesses of portions of the rolled thin plate 111′, which are removed through the first patterning and the second patterning, are the same, times for the first patterning and the second pattern may be substantially the same. Accordingly, sizes of the first inclination angle α and the second inclination angle β may be the same.

Furthermore, a size of the first inclination angle α and a size of the second inclination angle β may be the same, and the first inclination angle α and the second inclination angle β may be obtuse angles. Accordingly, the side part of the coil 111 may have a shape, a central portion of which protrudes.

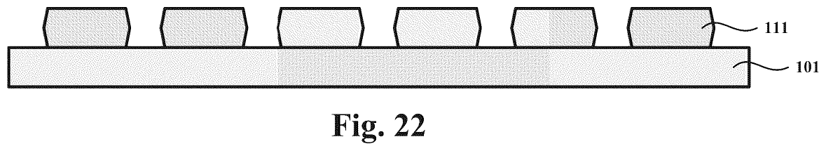

Meanwhile, FIGS. 21 and 22 illustrate as an example that the coil 111 has a shape, of which a central portion of the side part protrudes, but the present disclosure is not limited thereto. For example, the coil 111 may have a shape, of which the central portion of the side part is recessed. When the central portion of the side part of the coil 111 has a recessed shape, the size of the first inclination angle α and the size of the second inclination angle may be the same, and the first inclination angle α and the second inclination angle β may be acute angles.

When the second patterning is completed and the coil 111 is manufactured, as illustrated in FIG. 22, the second photoresist pattern PR2 on the rolled thin plate 111′ may be removed.

Meanwhile, although not illustrated on the drawings, after the coil 111 on the base 101 is manufactured according to necessities, the magnetic layer 113 as illustrated in FIG. 7B may be formed at at least a portion on the surface of the coil 111. The magnetic layer 113 may cover at least a portion of the exposed surface of the coil 111 while directly contacting the coil 111.

As described above, in the method for manufacturing the wireless charging coil module according to an embodiment of the present disclosure, the side part of the coil 111 may include the first inclined part 111ca and the second inclined part 111cb such that a central portion of the side part protrudes or is recessed, but a cross-section of the coil 111, which is perpendicular to the base 101 may have a shape that is close to a rectangular shape as a whole. This is because the first inclination angle α and the second inclination angle β of the first inclined part 111ca and the second inclined part 111cb are values that is close to 90°.

According to the present disclosure, the wireless charging coil module including the roller copper layer on one surface of the base, the method for manufacturing the same, and the wireless charging system including the same may allow high-speed charging of 30 W or more by manufacturing a coil by using the roller copper layer.

The present disclosure is not limited to the above-described embodiments, and it is apparent that a combination of two or more of the embodiments or a combination of at least one of the embodiments and a known technology is included as a new embodiment.

Until now, although the present disclosure has been described in detail through the detailed embodiment, the embodiment is for describing the present disclosure in detail, and the present disclosure is not limited thereto but may be modified or improved by an ordinary person in the art, to which the present disclosure pertains, without departing from the technical spirit of the present disclosure.

Simple modifications or changes of the present disclosure pertain to the areas of the present disclosure, and thus the protection scope of the present disclosure will become clearer by the attached claims.

What is claimed is:

1. A wireless charging coil module for wirelessly receiving or transmitting electric power or signals by using electromagnetic fields, the wireless charging coil module comprising:
a base; and
a coil part including a coil provided on one surface of the base to be rotated in one direction,
wherein the coil includes a rolled thin plate of a conductive metal disposed on the one surface of the base, and
wherein a side part of the coil has a shape, a central portion of which protrudes or is recessed.

2. The wireless charging coil module of claim 1, wherein a thickness of the coil is 60 μm to 500 μm.

3. The wireless charging coil module of claim 2, wherein the side part includes:
a first inclined part disposed adjacent to the base, and having a first inclination angle with respect to a lower surface of the coil; and
a second inclined part extending upwards from one end of the first inclined part, and having a second inclination angle with respect to an upper surface of the coil, and
wherein the first inclination angle and the second inclination angle are the same.

4. The wireless charging coil module of claim 3, wherein the side part of the coil has a shape, a central portion of which protrudes when the first inclination angle and the second inclination angle are obtuse angles.

5. The wireless charging coil module of claim 3, wherein the side part of the coil has a shape, a central portion of which is recessed when the first inclination angle and the second inclination angle are acute angles.

6. The wireless charging coil module of claim 3, further comprising:
a magnetic layer covering at least a portion of the coil while directly contacting the coil, and configured to act an electromagnetic booster that enhances an intensity of the electromagnetic field generated on the surface of the coil,
wherein the magnetic layer decrease, among a skin effect and a proximity effect of an eddy current generated in the coil, the proximity effect by isolating electric power in a gap of the coil that is rotated in the one direction.

7. The wireless charging coil module of claim 3, wherein the base includes at least one of polyimide (PI), polyethylene terephthalate (PET), and an epoxy resin.

8. A method for manufacturing a wireless charging coil module, the method comprising:
a rolled thin plate preparing operation of preparing a rolled thin plate of a conductive metal;
a first rolled thin plate patterning operation of performing first patterning by using a first photoresist pattern provided on the rolled thin plate;
a base attaching operation of disposing a base on a surface of the rolled thin plate, on which the first patterning is performed; and
a second rolled thin plate patterning operation of forming a coil disposed on the base by performing second patterning by using a second photoresist pattern provided on an opposite surface to the surface of the rolled thin plate, on which the base is disposed,
wherein the second photoresist pattern is provided in an area corresponding to the first photoresist pattern, and
wherein an area that is removed from the rolled thin plate through the first patterning and an area that is removed from the rolled thin plate through the second patterning are connected to each other.

9. The method of claim 8, wherein a side part of the coil has a shape, a central portion of which protrudes or is recessed.

10. The method of claim 9, wherein a thickness of the coil is 60 μm to 500 μm.

11. The method of claim 10, wherein the side part includes:
a first inclined part disposed adjacent to the base, and having a first inclination angle with respect to a lower surface of the coil; and
a second inclined part extending upwards from one end of the first inclined part, and having a second inclination angle with respect to an upper surface of the coil, and
wherein the first inclination angle and the second inclination angle are the same.

12. The method of claim 11, wherein the side part of the coil has a shape, a central portion of which protrudes when the first inclination angle and the second inclination angle are obtuse angles.

13. The method of claim 11, wherein the side part of the coil has a shape, a central portion of which is recessed when the first inclination angle and the second inclination angle are acute angles.

14. The method of claim 11, wherein a depth, by which the rolled thin plate is etched through the first patterning, is a half of a thickness of the rolled thin plate, and
a depth, by which the rolled thin plate is etched through the second patterning, is the half of the thickness of the rolled thin plate.

15. The method of claim 11, wherein the base includes at least one of polyimide (PI), polyethylene terephthalate (PET), and an epoxy resin.

16. The method of claim 8, wherein the first patterning and the second patterning are wet etching.

17. A wireless charging system comprising:
a wireless power receiving device including a receiver coil module; and
a wireless power transmitting device including a transmitter coil module,
wherein at least one of the receiver coil module and the transmitter coil module includes:
a base; and
a coil part including a coil provided on one surface of the base to be rotated in one direction,
wherein the coil includes a rolled thin plate of a conductive metal on the one surface of the base, and
wherein a side part of the coil has a shape, a central portion of which protrudes or is recessed.

18. The wireless charging system of claim 17, wherein a thickness of the coil is 60 μm to 500 μm.

19. The wireless charging system of claim 18, wherein the side part includes:
a first inclined part disposed adjacent to the base, and having a first inclination angle with respect to a lower surface of the coil; and
a second inclined part extending upwards from one end of the first inclined part, and having a second inclination angle with respect to an upper surface of the coil, and
wherein the first inclination angle and the second inclination angle are the same.

20. The wireless charging system of claim 19, further comprising:
a magnetic layer covering at least a portion of the coil while directly contacting the coil, and configured to act an electromagnetic booster that enhances an intensity of the electromagnetic field generated on the surface of the coil,
wherein the magnetic layer decrease, among a skin effect and a proximity effect of an eddy current generated in the coil, the proximity effect by isolating electric power in a gap of the coil that is rotated in the one direction.
